(19) United States
(12) Patent Application Publication
(10) Pub. No.: US 2025/0263932 A1
(43) Pub. Date: Aug. 21, 2025

(54) ARRANGEMENT

(71) Applicant: Sandvik Mining and Construction Oy, Tampere (FI)

(72) Inventors: Jani LIETONEN, Turku (FI); Esko LAIHONEN, Turku (FI)

(21) Appl. No.: 19/198,869

(22) Filed: May 5, 2025

Related U.S. Application Data
(62) Division of application No. 17/636,135, filed on Feb. 17, 2022, now Pat. No. 12,312,814.

(30) Foreign Application Priority Data
Aug. 31, 2018 (EP) 18192048.9

(51) Int. Cl. E04F 11/18; E21F 13/02

(52) U.S. Cl. CPC E04F 11/1865; E21F 13/025; Y10T 403/32336

(57) ABSTRACT

An arrangement for attaching a falling post on a base structure, the post being rotatably movable between a standing and a recumbent position. The arrangement includes a stand, wherein the post is attached pivotally to the stand by a pin. The stand includes at least one groove arranged laterally in respect to the post, and the post has at least one projection extending in a lateral direction from the post. The at least one groove is arranged with respect to the at least one projection such that when the stand is in the standing position, the at least one projection lies in the at least one groove and thereby locks the post in the standing position. The at least one projection is attached to the post such that it may move with respect to the stand in a longitudinal direction of the post.

### RELATED APPLICATION DATA

This application is a divisional of U.S. application Ser. No. 17/636,135 filed Feb. 17, 2022, which is a § 371 National Stage Application of PCT International Application No. PCT/EP2019/072132 filed Aug. 19, 2019,, with priority to EP 18192048.9 filed Aug. 31, 2018.

### TECHNICAL FIELD

The present disclosure relates to an arrangement for attaching a falling post on a base structure and a vehicle including the arrangement.

### BACKGROUND

Safety railings that can be tilted from a standing position to a lower or recumbent position are widely used in vehicles that have to move in narrow passages. One example of such vehicles are vehicles used in mines. The safety railings are required, e.g. during service and maintenance work of a vehicle when personnel has to work on the vehicle, but on the other hand, standing safety railings are vulnerable to damage when the vehicle moves in a mine.

A problem with known tilting safety railings is that the tilting operation is complicated and typically not executed by one operator.

### SUMMARY

Viewed from a first aspect, there can be provided an arrangement for attaching a falling post on a base structure, the post being rotatably movable between a standing and a recumbent position. The arrangement includes a stand having an attachment element for attaching the falling post to the base structure. The post is attached pivotally to the stand by a pin, the post having an ability to rotate from the standing position to the recumbent position with respect to the stand. The stand includes at least one groove arranged laterally with respect to the post. The post includes at least one projection extending in a lateral direction from the post. The at least one groove is arranged with respect to the at least one projection such that when the stand is in the standing position, the at least one projection lies in the at least one groove and thereby locks the post in the standing position.

The at least one projection is attached to the post such that it has an ability to move with respect to the stand in a longitudinal direction of the post. An exterior of the stand includes a guidance surface ending at the at least one groove, and arranged to lift the at least one projection and guide the projection to move in the at least one groove.

The arrangement further includes a lever attached rotatably in the stand. The lever includes a first end, a length of which is arranged to extend past the guidance surface when the post is in the recumbent position such that the at least one projection arranged to move on the guidance surface is arranged to push the first end of the lever and rotate the lever in a first direction therewith, and the at least one projection is arranged to push down the first end simultaneously while moving into the at least one groove, such that when the post is in the standing position the first end of the lever is situated under the at least one projection lying in the at least one groove, and wherein the lever being activated to rotate in a second direction opposite to the first direction, the first end of the lever is arranged to lift the at least one projection away from the at least one groove, thus allowing the post being moved towards the recumbent position.

Thereby a safety railing that is simple and easy to operate may be achieved.

In one embodiment, the at least one projection is arranged in the post movable in longitudinal direction of the post, connected with an actuator arranged in the post and arranged to urge the projection towards the pin and allow the projection being lifted by the guidance surface to move away from the pin. An advantage is that the structure of the post is simple.

In one embodiment, the at least one projection is arranged fixedly in the post, the stand includes vertically elongated mounting holes for receiving the pin attached to the post, such that the guidance surface is arranged to lift the pin and the post therewith in guidance of the elongated mounting hole, providing a structure of the arrangement that is simple.

In one embodiment, the at least one projection is arranged fixedly in the post, the post includes at least one vertically elongated mounting hole for receiving the pin attached to the stand, such that the guidance surface is arranged to lift the post therewith in guidance of the elongated mounting hole providing a structure of the arrangement that is simple.

In one embodiment, the stand includes two grooves arranged on opposite sides of the stand, and respectively, the post has two projections extending opposite directions from the post. Accordingly, a symmetrical and self-adaptable structure may be achieved.

In one embodiment, an upper section of the guidance surface has a convex profile. Hence, a continuously smooth movement of the projection may be achieved.

In one embodiment, the at least one groove has a rear edge that extends higher from the bottom of the groove than a front edge joining to the guidance surface, providing a simple means for stopping the movement of the projection.

In one embodiment, as the lever is in its extreme position in a second direction of rotation, wherein the first end of the lever is arranged to lie at the at least one groove, such that the first end is limiting the length of the at least one groove to a length shorter than the width of the projection, the lever thus prohibiting the projection entering in the groove. Accordingly, a simple structure for facilitating of handling of long safety railings may be achieved.

In one embodiment, the lever is dimensioned such that as the first end limits the length of the at least one groove to a length shorter than the width of the projection, wherein the second end of the lever is lying on the same side with the first end with relation to a vertical imaginary plane arranged in and parallel with a rotational pin of the lever. Hence, unintentional movement of the lever may be prevented.

In one embodiment, the lever has two first ends and an arc-like connecting piece therebetween, the arc-like connecting piece establishing the second end of the lever and providing a symmetrical and sturdy structure of the lever.

In one embodiment, the lever includes an extension extending to an opposite side of the stand as the second end of the lever. Accordingly, the arrangement can be operated casily from both sides of the safety railing.

The foregoing summary, as well as the following detailed description of the embodiments, will be better understood when read in conjunction with the appended drawings. It should be understood that the embodiments depicted are not limited to the precise arrangements and instrumentalities shown.

### BRIEF DESCRIPTION OF THE DRAWINGS

Some embodiments illustrating the present disclosure are described in more detail in the attached drawings, in which:

FIG. 1 is a schematic view of a safety railing including an arrangement for attaching a falling post according to the present disclosure.

FIG. 2 is a schematic perspective view of an arrangement for attaching a falling post in a first position.

FIG. 3 is a schematic perspective view of the arrangement shown in FIG. 2 in a second position.

FIG. 4 is a schematic perspective view of the arrangement shown in FIG. 2 in a second position.

FIG. 5 is a schematic perspective view of the arrangement shown in FIG. 2 in a second position.

FIG. 6 is a schematic perspective view of the arrangement shown in FIG. 2 in a second position.

FIG. 7 is a schematic perspective view of the arrangement shown in FIG. 2 in a second position.

FIG. 8 is a schematic perspective view of the arrangement shown in FIG. 2 in a second position.

FIG. 9 is a schematic perspective view of another embodiment of the arrangement.

FIG. 10 is a schematic perspective view of a third embodiment of the arrangement.

FIG. 11 is a schematic perspective view of a fourth embodiment of the arrangement.

In the figures, some embodiments are shown simplified for the sake of clarity. Similar parts are marked with the same reference numbers in the figures.

### DETAILED DESCRIPTION

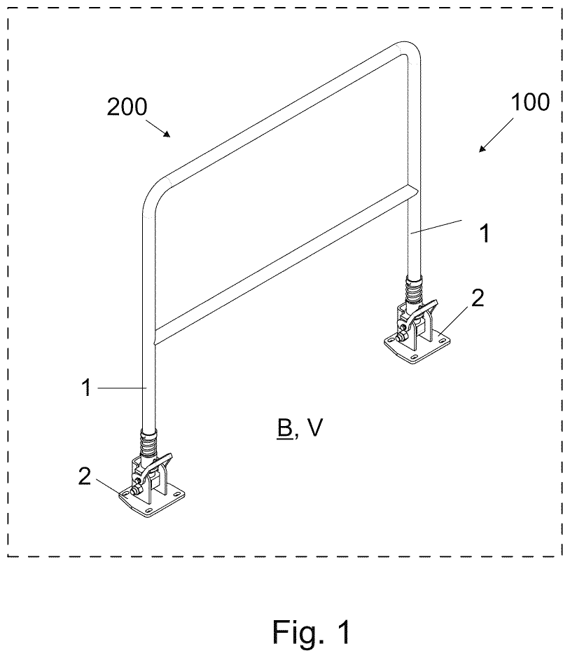

FIG. 1 is a schematic view of a safety railing 200 including an arrangement 100 for attaching a falling post of the present disclosure and arranged on a vehicle V. The vehicle V can be a mining vehicle or a construction vehicle. In mines and at other work sites different type of vehicles are used. The vehicles may be provided with one or more working devices for executing designed work tasks at the work site. Accordingly, the vehicle may be a wheel loader, a transport vehicle or dumper, a rock drilling rig, an excavator or a lifting machine, for example. However, the vehicle V may be any other type of a utility vehicle, such as a tractor, a truck, a farming machine, a forestry machine etc.

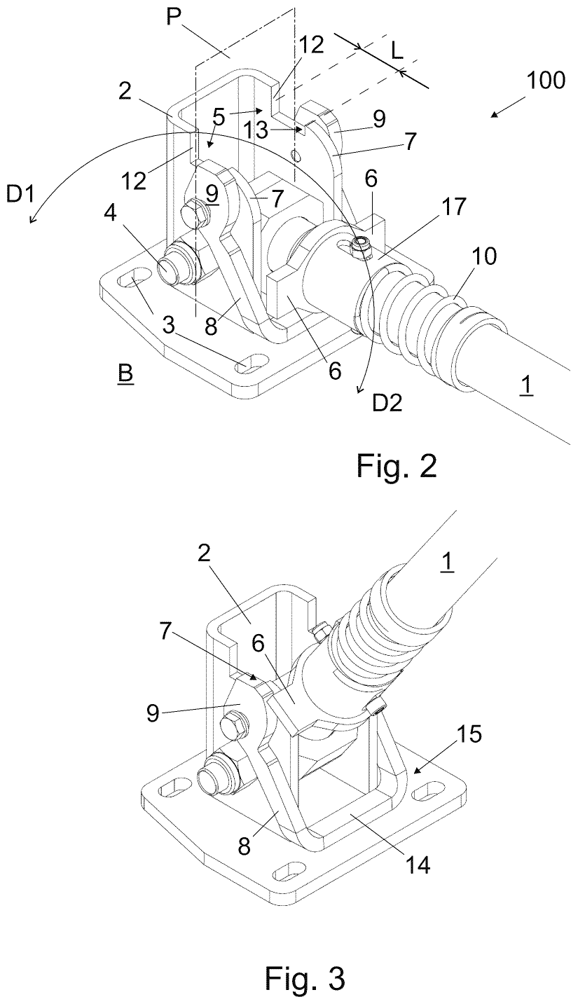

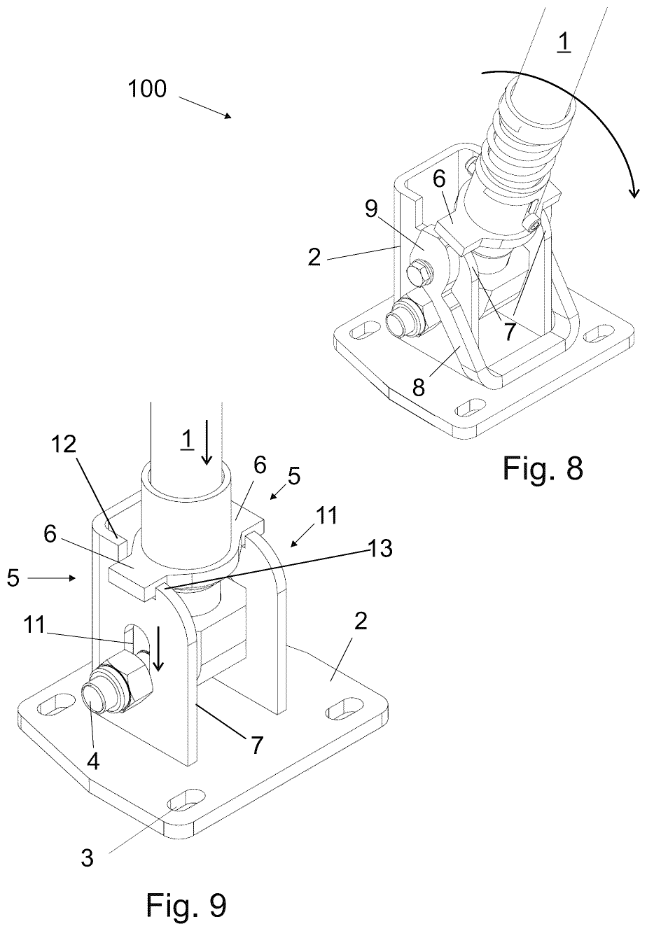

FIGS. 2-8 are schematic perspective views of an arrangement for attaching a falling post in various positions. The arrangement 100 includes a stand 2 that has an attachment element 3 for attaching the falling post 1 to a base structure B. The attachment element 3 shown in the figures includes bolt holes but, of course, the attachment element may incorporate other formations. The base structure B is a part or component of the vehicle V.

The post 1 is attached pivotally to the stand 2 by a pin or axle 4, the post 1 thus has the ability to rotate from a horizontal position to a vertical position, and vice versa, with respect to stand 2. The horizontal or recumbent position is shown in FIG. 2 and the vertical or standing position is shown in FIG. 5.

It is to be noted that “vertical or standing position” means herein a position where the post 1 lies when the safety railing 200 is arranged for securing safety of personnel, whereas “horizontal or recumbent position” means a position where the safety railing 200 has been lowered or overturned in order to lower the height thereof.

The stand 2 includes at least one groove 5 arranged laterally with respect to the post 1. In the embodiment shown in the figures, there are two grooves 5 arranged opposite sides of the stand 2.

The post 1 includes at least one projection 6 extending in a lateral direction from the post 1. In the embodiment shown in the figures, there are two projections 6 extending opposite directions from the post 1.

The grooves 5 are arranged with respect to the projections 6 such that when the post 1 is in the standing position (shown in FIG. 5), the projections 6 lie in the grooves 5, and thereby locking the post 1 in the standing position with respect to the stand 2.

The projections 6 are attached to the post 1 such that they may move with respect to the stand 2 in a longitudinal direction of the post 1. In the embodiment shown in FIGS. 1-8, the projections 6 are attached to a sleeve 17 that glides on the post 1. The sleeve includes two long apertures and the post 1 a bolt and nut arranged in the apertures. The apertures and the bolt and nut limit and guids the movement of the projections 6 on the post 1.

In an embodiment, an actuator 10 is arranged in the post 1. The actuator 10 is arranged to urge the projections 6 towards the pin 4 and allow the projections 6 being lifted by a guidance surface 7 to move away from the pin 4. In the embodiment shown in the figures, the actuator is a coil spring. However, the actuator may also be e.g. mechanical spring of another type, a gas spring etc.

In another embodiment, there is no actuator at all. Instead, the movement of the projections is caused by gravity of the projections 6.

The position and shape of the guidance surface 7 is designed such that the projections) 6 of raising post 1 contact a convex-shaped upper section of the guidance surface 7. This ensures a smooth and easy lift-up of the post 1, and also a reliable lifting of the projections 6.

It should be appreciated that the guidance surface 7 may have different shapes. For example, in an embodiment, the shape may also be straight.

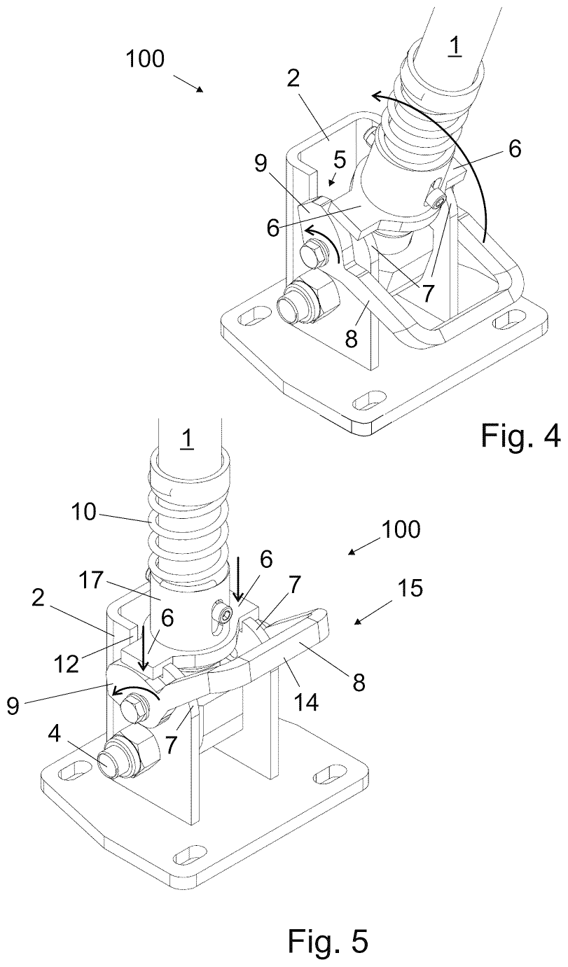

The exterior of the stand 2 includes guidance surfaces 7 that end at the grooves 5. The guidance surfaces 7 are arranged to lift (see FIGS. 3 and 4) the projections 6 during movement of the post 1 from its horizontal position to the vertical position and guide the projections 6 to move in the grooves 5. Furthermore, the pin 4 may be arranged eccentrically with respect to the convex-shaped upper sections, such that the distance of the upper part of the guidance surface 7 from the pin 4 is more than the distance in lower parts of the surface 7. Due to this feature, the projections 6 move away from the pin 4 during the raising of the post 1 and, simultaneously, the actuator 10 is “primed”, e.g. in case of a spring, the spring is tensioned. The tension is at least partly released when the projections move in the grooves 5.

The arrangement 100 includes a lever 8 rotatably attached to the stand 2. The lever 8 has a first end 9, a length of which is arranged to extend past the guidance surface 7 when the post 1 is in the horizontal position. Thus, the projections 6 that move on the guidance surface 7 together with raising the post will push the first end 9 of the lever and rotate the lever 8 in a first direction D1 therewith (shown in FIG. 2).

The projections 6 push the first ends 9 moving on the respective guidance surfaces 7 ahead (as shown in FIG. 4) until the projections 6 reach the grooves 5. Then the projections 6 move or drop into the grooves 5 and, simultaneously, push down the first ends 9 of the lever. As a result, the first ends 9 are situated under the projections 6 settled in the grooves 5. The post 1 and the safety railing 200 is then in the standing position and locked in this position by the projections 6 in the grooves 5 as shown in FIG. 5.

The movement of the projections 6 in the first direction D1 may be stopped just above the grooves 5 by a high rear edge 12 of the groove 5. According to the embodiments having two projections, such as shown in the figures the two projections center and guide themselves against respective rear edges. Thus, if any, play in the structure of the post and projections may be eliminated.

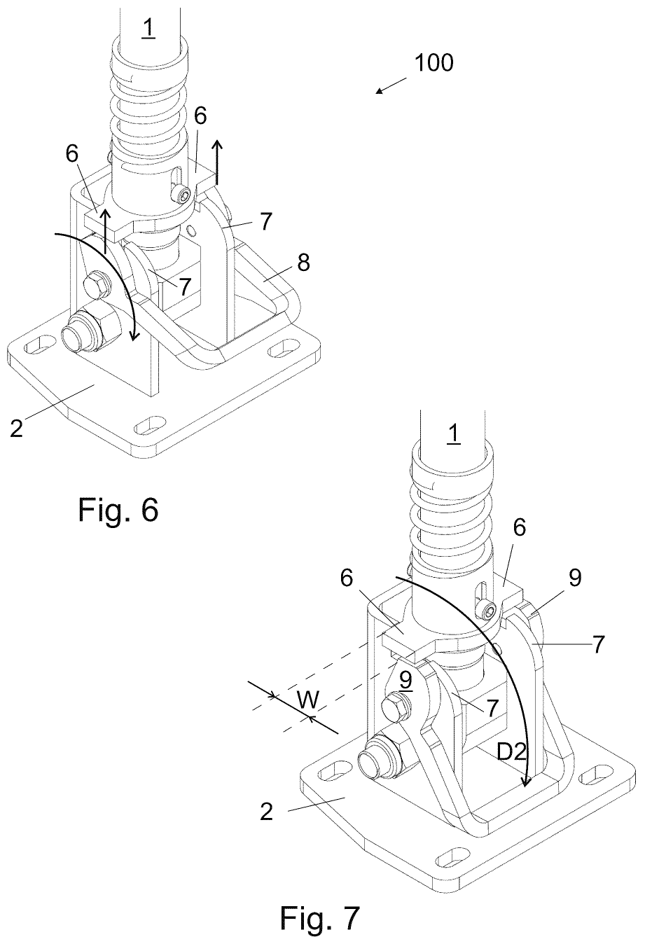

When the standing safety railing 200 has to be lowered, the lever 8 is activated to rotate in a second direction D2 opposite to the first direction. The activation may be done by pressing second end of lever 15, e.g., by foot. Then the first ends 9 of the lever are arranged to lift the projections 6 away from the respective grooves 5, as shown in FIG. 6. In this position of the projections 6, the post 1 is released and may be turn over to the horizontal position.

The lever 8 shown in the figures has two first ends 9 and an arc-like connecting piece 14 connecting the first ends. The arc-like connecting piece 14 establishes the second end 15 of the lever.

On one embodiment shown there are two grooves 5, two projections 6 and two guidance surfaces 7. In another embodiment, there is only one groove 5, one projection 6 and one guidance surface 7. Basically, it is preferable that the numbers of the grooves, projections and guidance surfaces are equal, but this is not compulsory.

According to the present disclosure, as the lever 8 is in its extreme position in a second direction D2 of rotation, the first end 9 thereof is arranged to limit a length L (shown in FIG. 2) of the groove 5 to a length shorter than width W (shown in FIG. 7) of the projection 6. An example of this position is shown in FIG. 7. Thus, the lever 8 prohibits the projection 6 entering in the groove 5. This may facilitate the operator's work especially when moving a safety railing 200 having at least two posts and arrangements 100 from a standing position to recumbent position. As the operator lifts the projections 6 away from the grooves 5 in one arrangement, the projections will not move back spontaneously in the grooves, but is/are supported by the first ends 9. Thus, the operator may leave the arrangement and concentrate to operate with a next arrangement 100. This way even a very long safety railing 200 can be turned over by just one operator.

FIG. 9 is a schematic perspective view of another embodiment of the arrangement. In an embodiment, the projection 6 is arranged fixedly in the post 1. The stand 2 has vertically elongated mounting holes 11 that receives the pin 4 attached to the post 1. The pin 4 and also the post 1 may move in the mounting holes 11 in a vertical direction. The guidance surface 7 lifts the projection 6, the pin 4 and the post 1 therewith such that the projection 6 enters at a corresponding groove 5, and then the projection 6 and the post 1 therewith drops in the groove 5.

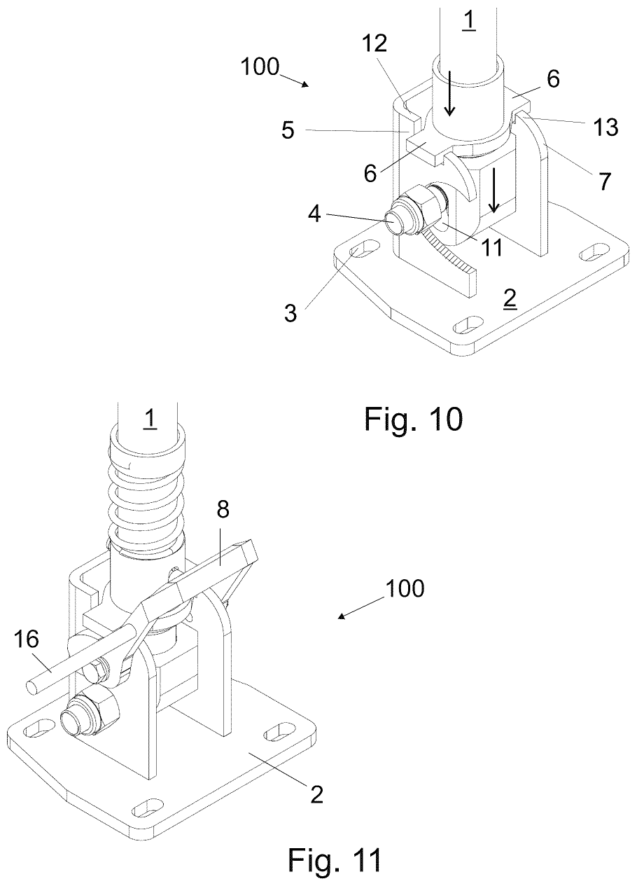

FIG. 10 is a schematic perspective view of a third embodiment of the arrangement. In this embodiment, the projection 6 is arranged fixedly in the post 1. The post 1 has a vertically elongated mounting hole 11 for receiving the pin 4 attached to the stand 2. The post 1 may move in relation to the pin 4 in direction of the elongation. The guidance surface 7 lifts the projection 6 and the post 1 therewith such that the projection 6 enters at a corresponding groove 5, and then the projection 6 and the post 1 therewith drops in the groove 5. It is to be noted that the lever 8 is not shown in FIG. 9 in order to simplify the presentation.

FIG. 11 is a schematic perspective view of a fourth embodiment of the arrangement in which there is an extension 16 in the lever 8 that extends to an opposite side of the stand 2 as the second end 15 of the lever. The extension 16 makes it easy to use the arrangement 100 from both sides of the safety railing 200.

Although the present embodiment(s) has been described in relation to particular aspects thereof, many other variations and modifications and other uses will become apparent to those skilled in the art. It is preferred therefore, that the present embodiment(s) be limited not by the specific disclosure herein, but only by the appended claims.

What is claimed is:

1. An arrangement attaching a falling post on a base structure, the post being rotatably movable between a standing and a recumbent position, the arrangement comprising:
a stand including an attachment element arranged for attaching the falling post to the base structure, wherein the post is attached pivotally to the stand by a pin, the post being arranged to rotate from the standing position to the recumbent position with respect to the stand, the stand having at least one groove arranged laterally with respect of the post, at least one projection extending in a lateral direction from the post, the at least one groove being arranged with respect to the least one projection such that when the post is in the standing position, the at least one projection lies in the at least one groove, and thereby locks the post in the standing position, the at least one projection being attached to the post and arranged to move with respect to the stand in a longitudinal direction of the post, an exterior of the stand including a guidance surface ending at the at least one groove, the guidance surface being arranged to lift the at least one projection along the post and guide the projection to move into the at least one groove; and
wherein the pin extends through the stand and is arranged to move vertically with the post in the stand such that as the at least one projection moves along the guidance surface the pin moves vertically.

2. The arrangement as claimed in claim 1, wherein the at least one projection is arranged fixedly to the post, the stand including vertically elongated mounting holes for receiving the pin attached to the post, such that as the at least one projection moves along the guidance surface the pin moves vertically within the elongated mounting hole.

3. The arrangement as claimed in claim 1, wherein the at least one projection is arranged fixedly to the post, the post including a vertically elongated mounting hole for receiving the pin attached to the stand, such that the guidance surface is arranged to lift the post therewith and the post is guided within the elongated mounting hole.

4. The arrangement as claimed in claim 1, wherein the at least one groove comprises two grooves, the two grooves being arranged on opposite sides of the stand, and wherein the post includes two projections extending in opposite directions from the post.

5. The arrangement as claimed in claim 1, wherein an upper section of the guidance surface has a convex profile.

6. The arrangement as claimed in claim 1, wherein the at least one groove includes a rear edge that extends higher from a bottom of the groove than a front edge joining the guidance surface.

7. The arrangement as claimed in claim 1, wherein the pin is arranged eccentrically with respect to the guidance surface, such that a distance of an upper part of the guidance surface from the pin is more than a distance between the pin and lower parts of the guidance surface.

8. The arrangement as claimed in claim 1, a lever rotatably attached on the stand, the lever including a first end, the at least one projection being arranged to move on the guidance surface to push the first end of the lever and rotate the lever in a first direction therewith, and the at least one projection being arranged to push down the first end simultaneously with moving into the at least one groove, such that when the post is in the standing position the first end of the lever is situated under the at least one projection lying in the at least one groove, and wherein the lever being arranged when activated to rotate in a second direction opposite to the first direction, the first end of the lever being arranged to lift the at least one projection away from the at least one groove, thus allowing the post to be moved towards the recumbent position.

9. A vehicle, comprising the arrangement as claimed in claim 1.

10. The vehicle as claimed in claim 9, wherein the vehicle is a mining vehicle, and wherein the arrangement is arranged in a safety railing of the mining vehicle.
